(19) United States
(12) Patent Application Publication
(10) Pub. No.: US 2026/0268592 A1
(43) Pub. Date: Sep. 10, 2026

(54) DISPLAYING A VIRTUAL ENVIRONMENT USING DYNAMICALLY-SHADED PLANES

(71) Applicant: thinAir Technologies, Inc., Covington, LA (US)

(72) Inventor: Jeremey Charbonnet, Covington, LA (US)

(21) Appl. No.: 19/555,315

(22) Filed: Mar. 3, 2026

Related U.S. Application Data
(60) Provisional application No. 63/767,877, filed on Mar. 6, 2025.

(51) Int. Cl. G06T 15/80; G06T 15/08; G06T 15/20

(52) U.S. Cl. CPC G06T 15/80; G06T 15/08; G06T 15/20

(57) ABSTRACT

A method includes determining a first point-of-view (POV) of 2D planes in a virtual environment from a user location characterized by a set of coordinates in the virtual environment and a distance between the 2D planes and the user location. The method includes applying a first set of shading patterns to the 2D planes based on the first POV in order to make the 2D planes appear as a three-dimensional (3D) virtual object from the first POV. The method includes in response to a change from the first POV to a second POV, determining a second set of shading patterns based on the second POV in order to make the 2D planes appear as the 3D virtual object from the second POV. The method includes displaying, on the display, the 2D planes with the second set shading patterns.

### CROSS-REFERENCE TO RELATED APPLICATIONS

This application claims priority to U.S. Provisional Patent App. No. 63/767,877, filed on March 6, 2025, which is hereby incorporated by reference in its entirety.

### TECHNICAL FIELD

The present disclosure generally relates to displaying a virtual environment using dynamically-shaded planes.

### BACKGROUND

Some devices include a display. Some devices display a virtual environment on the display. Displaying virtual environments can be resource-intensive. For example, rendering virtual environments in three dimensions (3D) is power-intensive. As such, rendering virtual environments in 3D can drain a battery of a battery-operated device and cause excessive heating in a portable electronic device.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1F are diagrams of an example environment in accordance with some implementations.

FIG. 2A is a block diagram of a system that utilizes dynamic shading in accordance with some implementations.

FIG. 2B is a diagram that illustrates use of dynamic shading patterns in accordance with some implementations.

FIG. 3 is a flowchart representation of a method of dynamic shading in accordance with some implementations.

FIG. 4 is a block diagram of a device that implements dynamic shading in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying virtual environments using dynamically-shaded planes. In some implementations, a device includes a display, an input device, one or more processors and a non-transitory memory. In various implementations, a method includes determining a first point-of-view (POV) of a set of two or more two-dimensional (2D) planes in a virtual environment from a user location characterized by a set of coordinates in the virtual environment and a distance between the set of two or more 2D planes and the user location. In some implementations, the method includes applying a first set of one or more shading patterns to the set of two or more 2D planes based on the first POV in order to make the set of two or more 2D planes appear as a three-dimensional (3D) virtual object from the first POV. In some implementations, the method includes in response to a change from the first POV to a second POV, determining a second set of one or more shading patterns based on the second POV in order to make the set of two or more 2D planes appear as the 3D virtual object from the second POV. In some implementations, the method includes displaying, on the display, the set of two or more 2D planes with the second set of one or more shading patterns.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Volumetric virtual environments and volumetric virtual objects within the virtual environment are resource intensive to render continuously. As a result, as a number of volumetric virtual objects in a scene increases the frame rate typically has to drop to accommodate increasing numbers of volumetric virtual objects. Decreasing the frame rate adversely impacts a user experience provided by the device. Furthermore, continuously utilizing a renderer to render virtual environments and objects in three dimensions (3D) increases a utilization of computing resources. Increased utilization of computing resources drains a battery of a battery-operated device. Moreover, continuously utilizing the renderer to render virtual objects in 3D tends to result in overheating of the device. The overheating is exacerbated for portable electronic devices with limited heat dissipation capabilities, in particular for wearable electronic devices such as a head-mountable device (HMD) which becomes unusable in a safe manner when overly-hot.

The present disclosure provides methods, systems, and/or devices for displaying virtual environments and virtual objects within the virtual environment using fewer computing resources. Instead of always rendering a portion of a virtual environment in 3D, a device sometimes displays a set of two or more two-dimensional (2D) planes that represent a portion of the 3D virtual environment or a 3D virtual object within the 3D virtual environment. The device applies a suitable shading pattern to the set of 2D planes in order make the 2D planes look similar to the portion of the 3D virtual environment or the 3D virtual object that the 2D planes represent. The device varies the shading pattern based on a distance between the set of 2D planes and a point-of-view (POV) corresponding to a user location. Dynamically changing the shading pattern that is applied to the set of 2D planes makes the set of 2D planes appear as the portion of the 3D virtual environment that the set of 2D planes represents. Changing the shading pattern that is applied to the set of 2D planes is computationally cheaper than using a renderer to render the representative portion of 3D virtual environment or the 3D virtual object in 3D. Since dynamically shading the 2D planes has a lower computational overload than rendering the portion of the 3D virtual environment, changing the shading pattern uses less power than 3D rendering of the entire virtual environment. As such, dynamically applying a shading pattern to the set of 2D planes extends a battery life of a battery-operated device. Furthermore, since dynamically shading the set of 2D planes uses less graphics processing resources than 3D rendering, changing the shading pattern results in less heat generation which allows the user of an HMD to use the HMD in a safe manner for a prolonged period of time thereby improving a functionality of the device. Moreover, lowering the computational overload by displaying dynamically-shaded 2D planes instead of 3D virtual objects allows the device to maintain a frame rate above an acceptable frame rate thereby enhancing a user experience provided by the device.

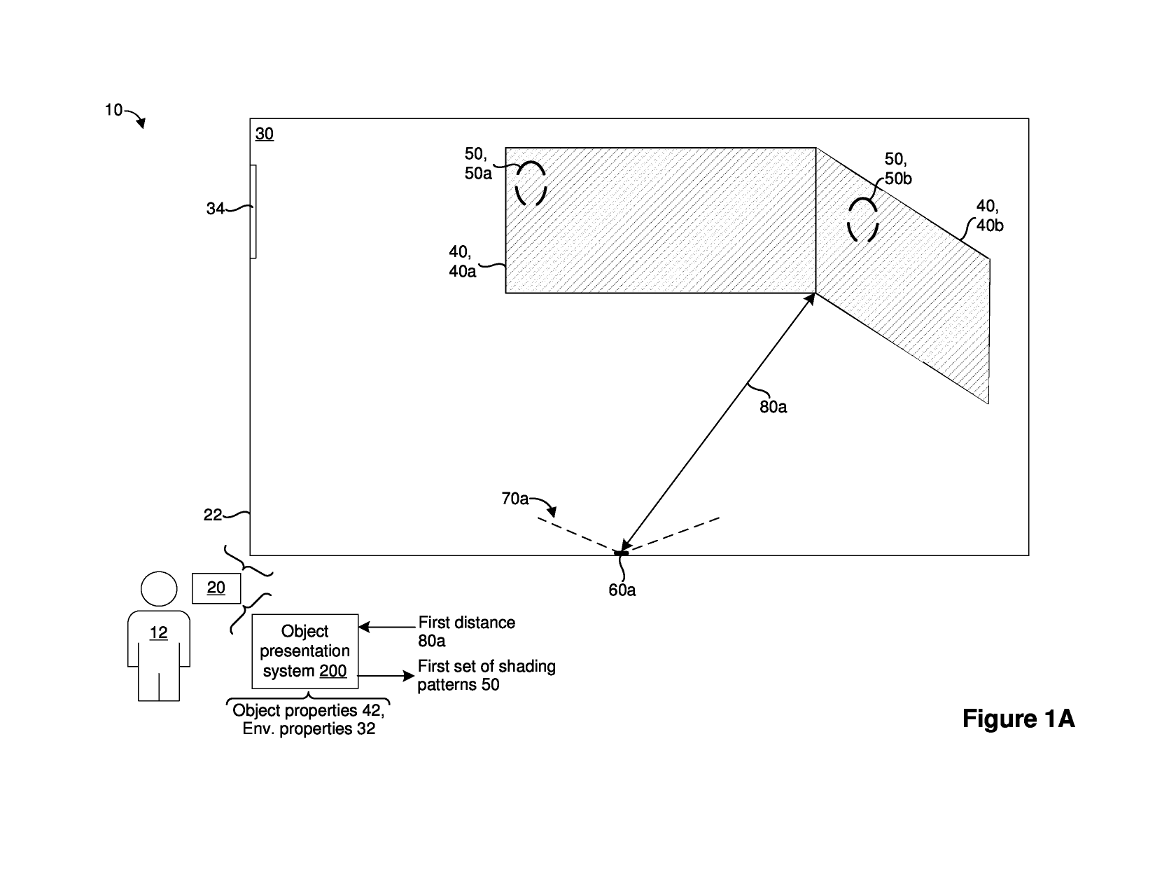

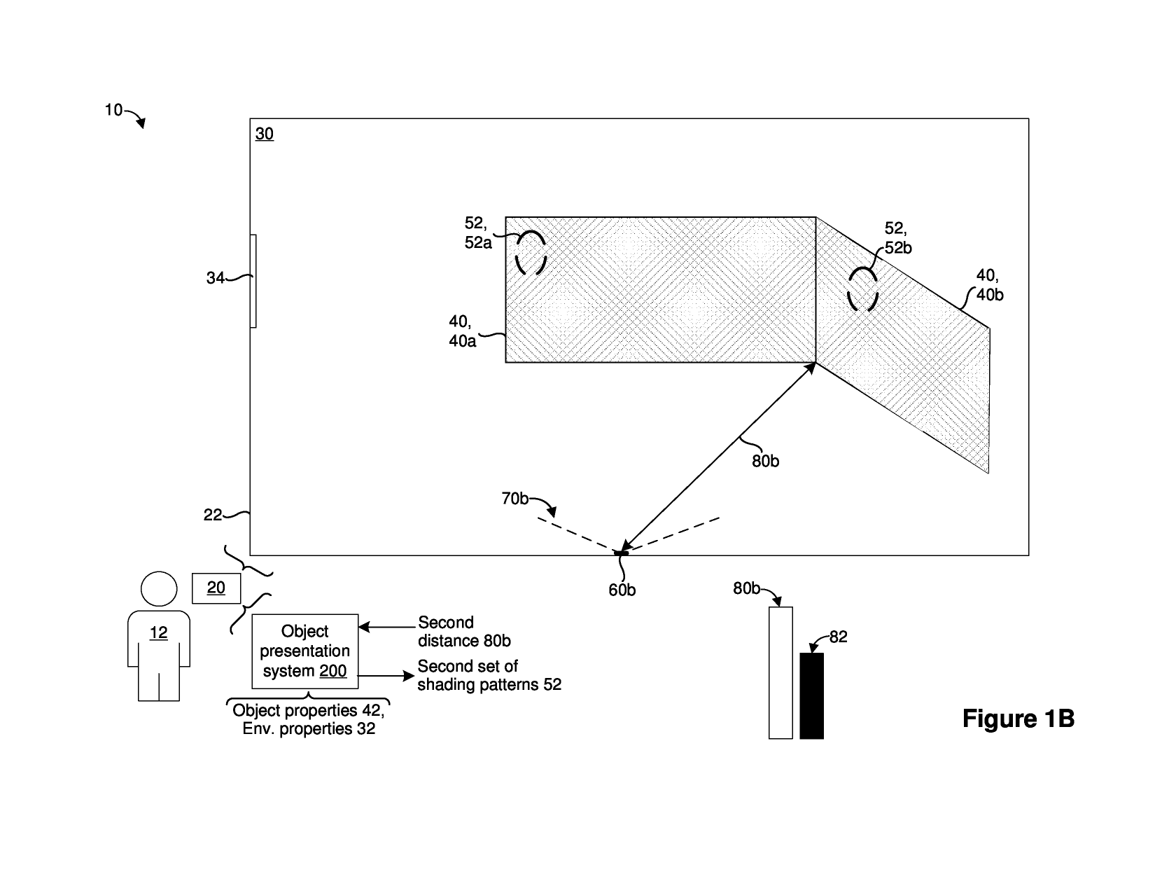

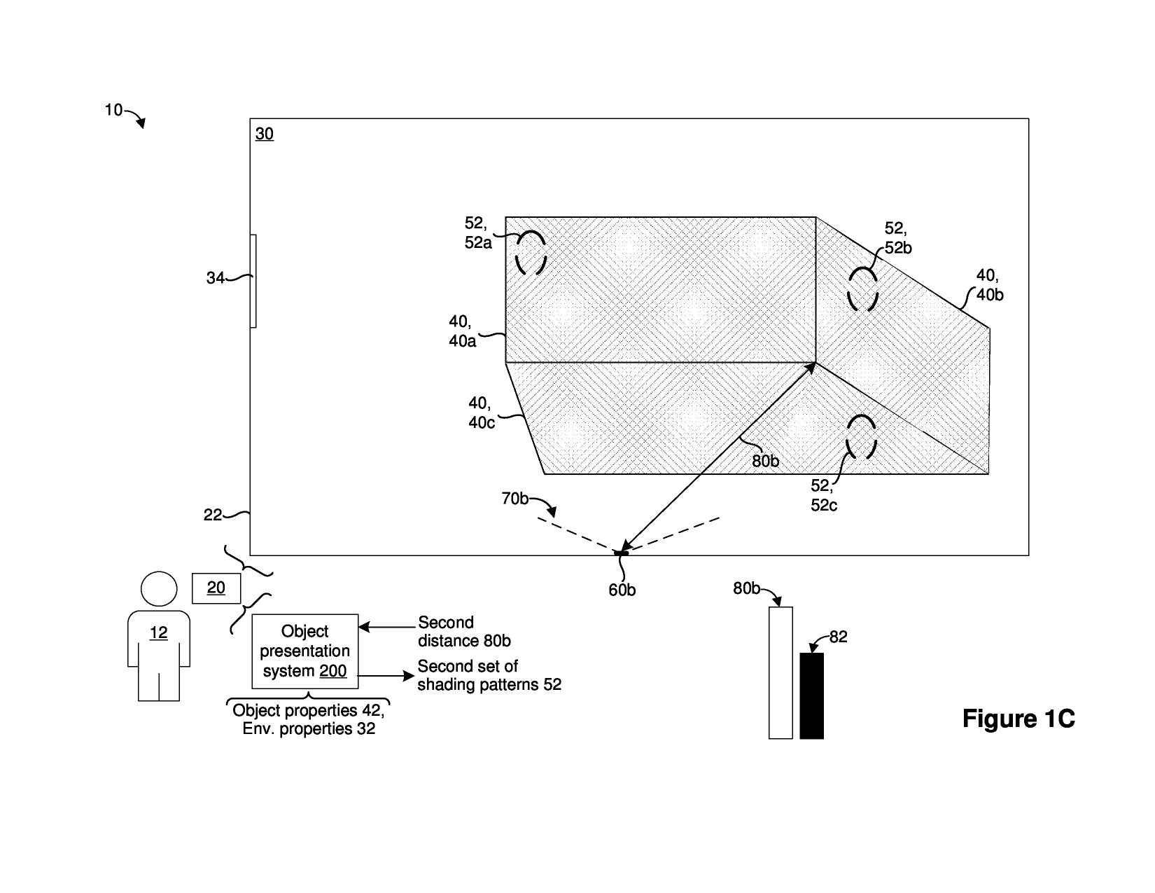

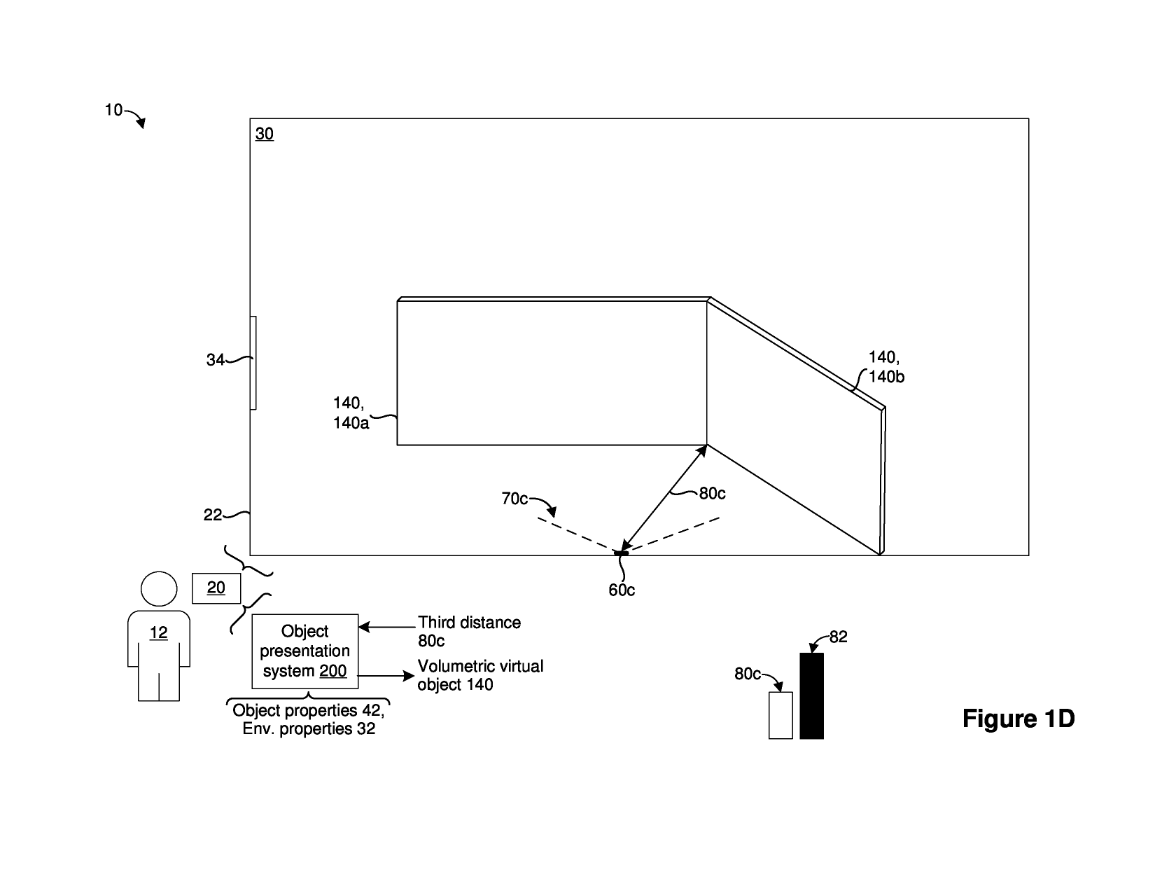

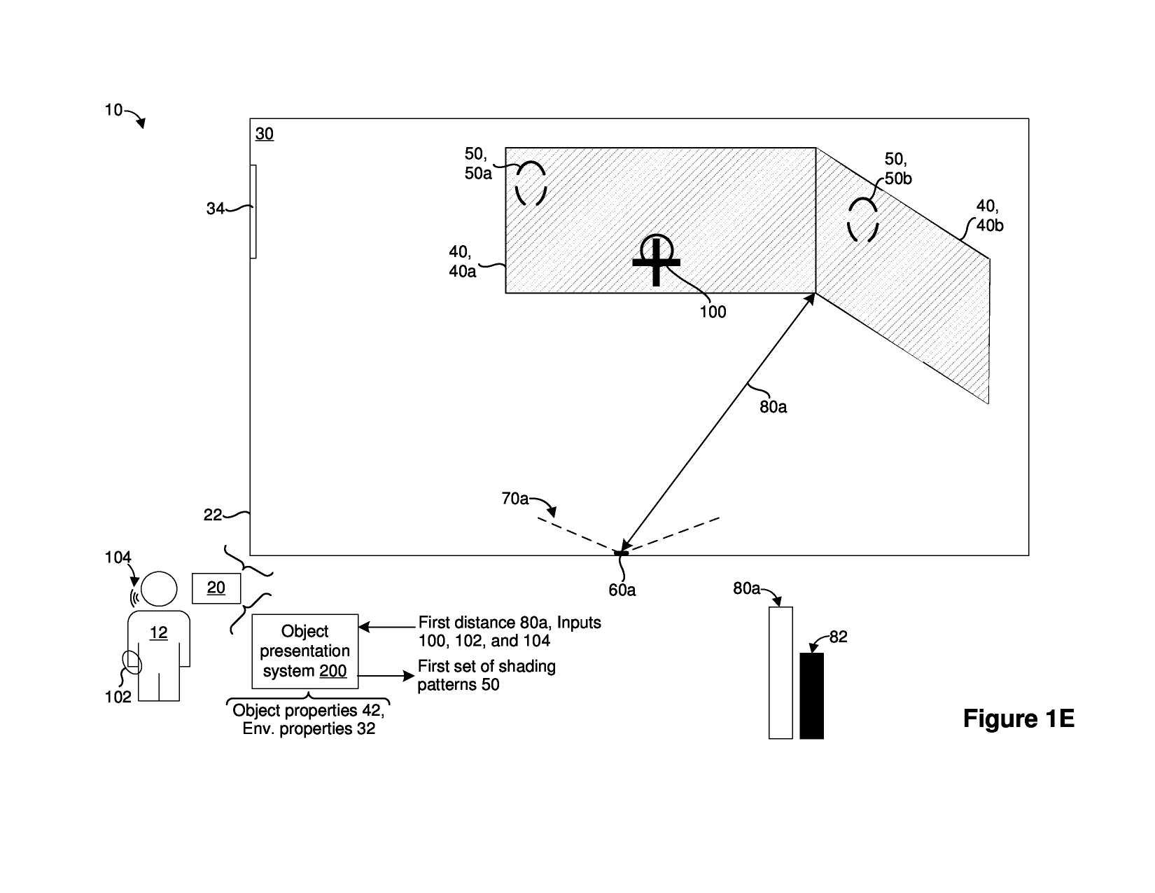

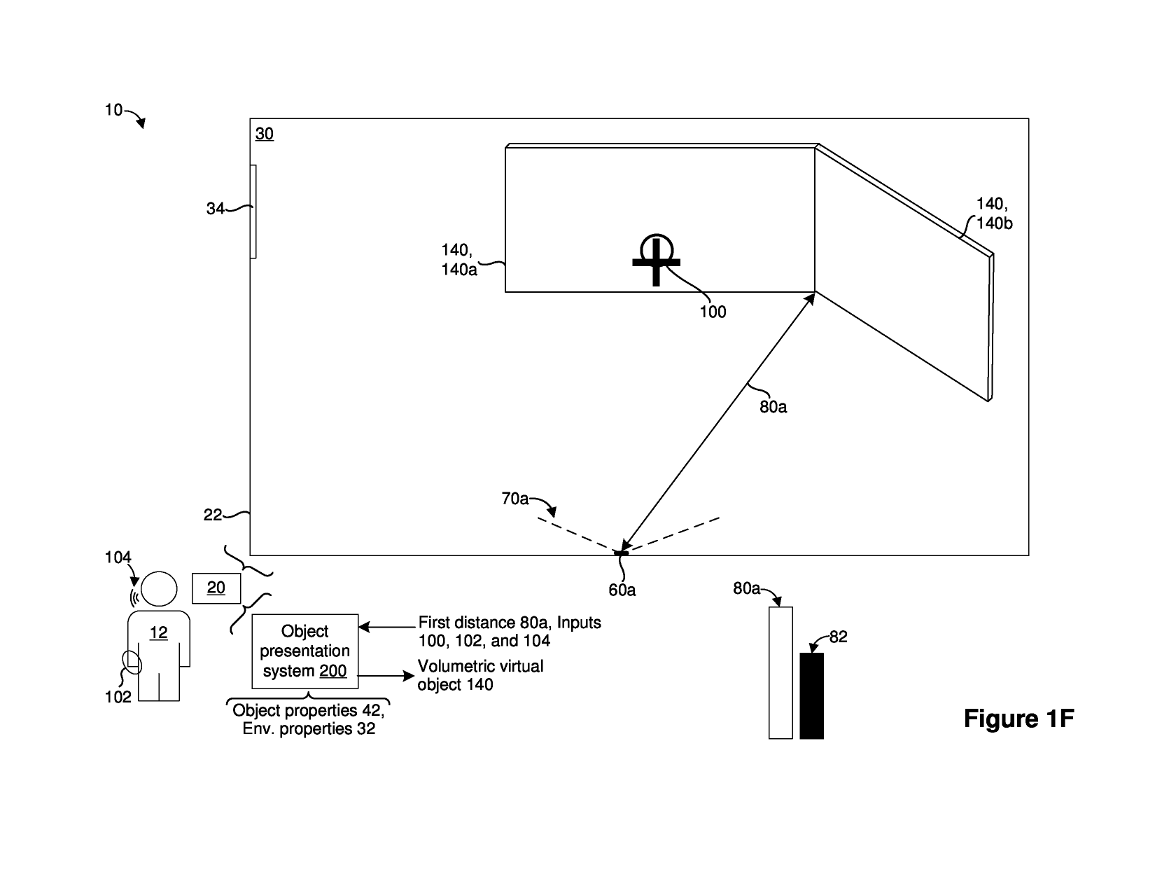

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity) with a display 22, and an object presentation system 200 for displaying virtual environments and virtual objects within the virtual environments. In some implementations, the object presentation system 200 resides at the device 20. Alternatively, in some implementations, the object presentation system 200 resides at another device that is in electronic communication with the device 20. For example, the device 20 includes a head-mountable device (HMD) and the object presentation system 200 resides at a smartphone that is wirelessly connected with the HMD.

In the example of FIG. 1A, the device 20 displays an extended reality (XR) environment. In some implementations, the XR environment is a pass-through representation of the physical environment 10. Alternatively, in some implementations, the XR environment is a three-dimensional (3D) virtual environment 30 (“3D virtual environment 30” or “virtual environment 30”, hereinafter for the sake of brevity). In the example of FIG. 1A, the virtual environment 30 includes a set of two or more two-dimensional (2D) planes 40 (“2D planes 40”, hereinafter for the sake of brevity). The 2D planes 40 represent a portion of the 3D virtual environment 30. The 2D planes 40 include a first 2D plane 40a that represents a first 3D wall of the 3D virtual environment 30 and a second 2D plane 40b that represents a second 3D wall of the 3D virtual environment 30. In the example of FIG. 1A, the first 2D plane 40a and the second 2D plane 40b intersect to form an edge. However, in some implementations, the 2D planes 40 do not intersect. For example, the 2D planes 40 may be parallel (e.g., when the 2D planes represent opposing walls of the 3D virtual environment 30). In some implementations, the 2D planes 40 may overlap (e.g., when the 2D planes 40 represent 3D walls that are adjacent). Alternatively, in some implementations, the 2D planes 40 may be separated by a distance.

The object presentation system 200 displays the 2D planes 40 with a first set of shading patterns 50 in order to provide an appearance that the 2D planes 40 are a portion of the 3D virtual environment 30. In other words, applying the first set of shading patterns 50 to the 2D planes 40 makes the 2D planes 40 look 3D instead of 2D. As such, the device 20 can conserve 3D rendering resources by displaying the 2D planes 40 with the first set of shading patterns 50 instead of rendering the representative portion of the 3D virtual environment 30 in 3D. The first set of shading patterns 50 may include a first shading pattern 50a for the first 2D plane 40a and a second shading pattern 50b for the second 2D plane 40b. The first shading pattern 50a makes the first 2D plane 40a look like a 3D virtual object (e.g., a first 3D virtual wall) and the second shading pattern 50b makes the second 2D plane 40b look like another 3D virtual object (e.g., a second 3D virtual wall that intersects the first 3D virtual wall). The first set of shading patterns 50 is indicated by rightward slanted hatching in FIG. 1A.

In the example of FIG. 1A, the device 20 displays the virtual environment 30 from a first user location 60a within the virtual environment 30. The first user location 60a corresponds to a first set of three-dimensional (3D) coordinates within the virtual environment 30. The first user location 60a is associated with a first point-of-view (POV) 70a. In the example of FIG. 1A, the first POV 70a is conical. Areas of the virtual environment 30 that are within the first POV 70a are visible to the user 12 while a remainder of the virtual environment 30 is not visible to the user 12. The first user location 60a is a first distance 80a from the 2D planes 40. In the example of FIG. 1A, the first distance 80a is measured from the first POV 70a to the intersection of the first 2D plane 40a and the second 2D plane 40b. Alternatively, the first distance 80a can be measured from the first POV 70a to a point on the 2D planes 40 that is closest to the first POV 70a. In some implementations, the device 20 identifies 3D coordinates of a portion of the 3D virtual environment 30 or a 3D virtual object that the 2D planes 40 represent, and the first distance 80a represents a difference between the first user location 60a and the 3D coordinates of the portion of the 3D virtual environment 30 of the 3D virtual object represented by the 2D planes 40.

In some implementations, the first set of shading patterns 50 is a function of the first distance 80a. For example, as shown in FIG. 1A, the object presentation system 200 accepts a value representing the first distance 80a as an input and outputs parameter values corresponding to the first set of shading patterns 50. In this example, the device 20 applies the parameter values corresponding to the first set of shading patterns 50 to the 2D planes 40 in order to make the 2D planes 40 simulate the appearance of a set of 3D virtual objects (e.g., 3D virtual walls) from the first POV 70a. Applying the first set of shading patterns 50 to the 2D planes 40 is less resource-intensive than displaying a set of 3D virtual objects that the 2D planes 40 represent. For example, displaying the 2D planes 40 with the first set of shading patterns 50 reduces the need to invoke a 3D object renderer that renders the set of 3D virtual objects thereby conserving graphics processing time and power that the 3D object renderer would consume. Hence, displaying the 2D planes 40 with the first set of shading pattern 50 improves a functionality of the device 20 by reducing resource utilization, decreasing power consumption and lowering heat generation thereby allowing the user 12 to use the device 20 safely for an extended time duration.

In some implementations, the object presentation system 200 utilizes a shading model to generate the first set of shading patterns 50. In some implementations, the shading model uses flat shading by applying a uniform shading across the 2D planes 40. The object presentation system 200 can use flat shading when the 2D planes 40 represent relatively simple 3D virtual objects with less than a threshold number of polygons. In some implementations, the shading model uses Gourad shading by calculating lighting at vertices and interpolating the shading across a surface connecting the vertices. In some implementations, the shading model uses Phong shading by calculating lighting at each pixel which results in a smoother and more accurate shading effect than flat shading or Gourad shading.

In some implementations, the object presentation system 200 determines the first set of shading patterns 50 based further on environment properties 32 that characterize the virtual environment 30. In some implementations, the environment properties 32 indicate a lighting level of the virtual environment 30. For example, the environment properties 32 indicate an ambient lighting level of the virtual environment 30, locations of light sources, intensities of light sources and/or colors of light emitted by the light sources. In the example of FIG. 1A, the virtual environment 30 includes a window 34. As such, the environment properties 32 may indicate an amount of virtual daylight entering from the window 34 and reaching the location of the 2D planes 40. In some implementations, the object presentation system 200 (e.g., a shading model utilized by the object presentation system 200) accepts the environment properties 32 (e.g., a light intensity value, a light illumination angle, a light color, etc.) as additional inputs and generates the first shading pattern 50a based further on the environment properties 32.

In some implementations, the object presentation system 200 determines the first set of shading patterns 50 based further on object properties 42 that characterize the set of 3D virtual objects that the 2D planes 40 represent (e.g., properties of the 3D virtual walls that the 2D planes 40 represent). In some implementations, the object properties 42 indicate a set of one or more colors of the 3D virtual object(s). In some implementations, the object properties 42 include a reflectivity value that indicates a reflectivity of the 3D virtual object(s) (e.g., a shininess level of the 3D virtual object(s), for example, how shiny the 3D virtual walls are). In some implementations, the object properties 42 indicate a set of one or more materials that the 3D virtual object(s) is(are) constructed from (e.g., leather, wood, stone, etc.). In some implementations, the object properties 42 indicate a texture of the 3D virtual object(s) (e.g., how it feels to touch a 3D virtual ceiling, for example, whether the 3D virtual ceiling has a popcorn finish with raised bumps). In some implementations, the object presentation system 200 (e.g., the shading model utilized by the object presentation system 200) accepts the object properties 42 (e.g., color, reflectivity, materials, texture, etc.) as additional inputs and generates the first set of shading patterns 50 based further on the object properties 42.

In some implementations, a set of shading patterns is characterized by a set of parameter values for various parameters. In some implementations, a shading pattern is associated with a set of values for color parameters. The color parameters may include a base color which indicates a starting color of the shading pattern, an end color indicating a final color in a gradient-type shading pattern, and intermediate colors at specific points in a multi-stop gradient. In some implementations, a shading pattern is associated with gradient parameters for gradient shading. The gradient parameters may include a start point of the gradient, an end point of the gradient, gradient stops indicating specific points where specific colors are applied along the gradient, and gradient type such as linear, radial, conical or angular. In some implementations, a shading pattern is characterized by lighting parameters, for example, an ambient light intensity parameter indicating baseline illumination unaffected by object orientation, a diffuse light intensity parameter indicating light scattered uniformly across a surface, a specular light intensity parameter indicating light reflected in a specific direction causing highlights, a light source direction defining light’s origin or direction, and a shininess or Phong exponent indicating a sharpness of specular highlights. In some implementations, a shading pattern is characterized by texture parameters, opacity or transparency parameters, a reflectivity parameter, a refractivity parameters, pattern-specific parameters (e.g., frequency defining how often a pattern repeats, amplitude defining intensity of the pattern, phase offset defining shifts in pattern along an axis and noise level for procedural or stochastic patterns).

In some implementations, each shading pattern in a set of shading patterns is different. For example, the first shading pattern 50a may be different from the second shading pattern 50b. In some implementations, each shading pattern is a function of various properties of the 2D plane that the shading pattern is applied to. For example, in some implementations, differences in the shading patterns in a set of shading patterns are a result of how the 2D planes are positioned with respect to the user location. As an example, the first shading pattern 50a and the second shading pattern 50b may be different due to differences in angles between a user plane and the 2D planes 40.

Referring to FIG. 1B, the device 20 presents (e.g., displays) the virtual environment 30 from a second user location 60b that provides a second POV 70b of the virtual environment 30. The second user location 60b corresponds to a second set of 3D coordinates within the virtual environment 30. The second user location 60b is different from the first user location 60a shown in FIG. 1A. For example, the second user location 60b is closer to the 2D planes 40 than the first user location 60a. The second user location 60b is a second distance 80b from the 2D planes 40.

The second distance 80b is greater than a threshold distance 82. In response to the second distance 80b being greater than the threshold distance 82, the object presentation system 200 determines to continue presenting the 2D planes 40 instead of switching to displaying the 3D virtual object(s) that the 2D planes 40 represent. However, in order to provide an appearance that the 2D planes 40 are 3D virtual objects, the object presentation system 200 determines a second set of shading patterns 52 for the 2D planes 40 based on the second distance 80b. For example, the device 20 determines a third shading pattern 52a for the first 2D plane 40a and a fourth shading pattern 52b for the fourth 2D plane 40b. The device 20 applies the second set of shading patterns 52 to the 2D planes 40 in order to maintain an appearance that the 2D planes 40 are 3D virtual objects. As can be seen in FIG. 1B, the second distance 80b is less than the first distance 80a shown in FIG. 1A. A virtual representation of the user 12 (e.g., an avatar of the user 12 or a virtual character representing the user 12) within the virtual environment 30 may have moved from the first user location 60a shown in FIG. 1A to the second user location 60b shown in FIG. 1B. The second set of shading patterns 52 is indicated by cross hatching which is different from rightward slanted hatching representing the first set of shading patterns 52 shown in FIG. 1A.

Changing the shading pattern of the 2D planes 40 from the first set of shading pattern 50 to the second set of shading patterns 52 maintains an illusion that the 2D planes 40 are 3D virtual objects. Changing from the first set of shading patterns 50 to the second set of shading patterns 52 reduces the need to invoke a 3D object renderer that would consume more power and graphics computing resources than what is required to determine and apply the second set of shading patterns 52 to the 2D planes 40. Therefore, determining and applying the second set of shading patterns 52 to the 2D planes 40 improves a functionality of the device 40 by reducing heat generation associated with 3D object rendering and extending a battery life of the device 20 thereby allowing the user 12 to safely use the device 40 for an extended period of time.

Referring to FIG. 1C, in some implementations, the device 20 changes an arrangement of the 2D planes 40 based on a change in the user location. For example, the device 20 changes a number of 2D planes that are displayed based on the user location. In the example of FIG. 1C, the device 20 displays a third 2D plane 40c that corresponds to a virtual floor of the 3D virtual environment 30. The device 20 applies a fifth shading pattern 52c to the third 2D plane 40c in order to provide an appearance that the third 2D plane 40c represents a 3D virtual floor of the virtual environment 30. As an example, the fifth shading pattern 52c may include visual variations that the 3D virtual floor includes (e.g., changes in grain of a virtual wooden floor). In some implementations, the device 20 changes a positioning of the 2D planes 40 based on the change in the user location in order to maintain an appearance that the 2D planes 40 are 3D virtual objects.

Referring to FIG. 1D, the device 20 presents (e.g., displays) the virtual environment 30 from a third user location 60c that provides a third POV 70c of the virtual environment 30. The third user location 60c corresponds to a third set of 3D coordinates within the virtual environment 30. The third user location 60c is different from the first user location 60a and the second user location 60b. For example, the third user location 60c is closer to a location corresponding to the 3D virtual object(s) that the 2D planes 40 represent than the first user location 60a and the second user location 60b. The third user location 60c is a third distance 80c from the location corresponding to the 3D virtual object. The object presentation system 200 switches from displaying the 2D planes 40 to displaying a set of 3D volumetric virtual objects 140 (“3D virtual objects 140”, hereinafter for the sake of brevity) that the 2D planes 40 represent in response to the third distance 80c being less than the threshold distance 82. The 3D virtual objects 140 include a first 3D volumetric virtual object 140a (“first 3D virtual object 140a”, hereinafter) and a second 3D volumetric virtual object 140b (“second 3D virtual object 140b”). In the example of FIG. 1D, the 3D virtual objects 140 are 3D virtual walls. For example, the first 3D virtual object 140a is a first 3D virtual wall and the second 3D virtual object 140b is a second 3D virtual wall that intersects the first 3D virtual wall.

When the third distance 80c is less than the threshold distance 82, it becomes increasingly difficult to maintain the illusion of the 2D planes 40 being 3D virtual objects. As such, switching to displaying the 3D virtual objects 140 provides a better user experience than displaying the 2D planes 40 shown in FIGS. 1A and 1B. Displaying the 3D virtual objects 140 may require invoking a 3D object renderer which consumes additional graphics processing resources and power, and generates additional heat in comparison to displaying the 2D planes 40. However, by delaying the presentation of the 3D virtual objects 140 until the user 12 is within the threshold distance 82 of the 3D virtual objects 140, the device 20 conserves scarce graphics computing resources and power, and reduces heat generation thereby enhancing a functionality of the device 20 by allowing the user 12 to use the device 20 for an extended period of time in a safe manner.

Referring to FIGS. 1E and 1F, in some implementations, the object presentation system 200 switches from displaying the 2D planes 40 to displaying the 3D virtual objects 140 based on a user input directed to the 2D planes 40. In some implementations, the user input includes a gaze input 100 that is directed to the 2D planes 40. In some implementations, when the user 12 is gazing at the 2D planes 40, the object presentation system 200 replaces the 2D planes 40 with the 3D virtual objects 140 as shown in FIG. 1F. In some implementations, the user input includes a gesture input 102 that is directed to the 2D planes 40. For example, the gesture input 102 may include a pointing gesture (e.g., requesting a distance between the 3D virtual wall and the third user location 60c). In some implementations, when the user 12 gestures at the 2D planes 40, the object presentation system 200 replaces the 2D planes 40 with the 3D virtual objects 140 as shown in FIG. 1F. In some implementations, the user input includes a verbal command 104 that is directed at the 2D planes 40. For example, the user 12 may say “size?” while gazing at the 2D planes 40 indicating a request for dimensions of the 3D virtual wall represented by the first 2D plane 40a. In some implementations, when the device 20 detects the verbal command 104 directed at the 2D planes 40, the object presentation system 200 replaces the 2D planes 40 with the 3D virtual objects 140 as shown in FIG. 1F. The user inputs 100, 102 and 104 indicate a user interaction with the 2D planes 40. Replacing the 2D planes 40 with the 3D virtual objects 140 in response to detecting the user interaction with the 2D planes 40 enhances a user experience by providing the more interactable (e.g., rotatable, moveable or animatable) 3D virtual objects 140 instead of the static (e.g., not interactable, for example, nonrotating, nonmoving or inanimate) 2D planes 40. In some implementations, the object presentation system 200 switches from displaying the 2D planes 40 to displaying the 3D virtual objects 140 based on a user interaction with the 2D planes 40 even when the user 12 is not within the threshold distance 82 of the 2D planes 40.

In some implementations, the object presentation system 200 switches from displaying the 3D virtual objects 140 to displaying the 2D planes 40 based on a user input directed away from the 3D virtual objects 140 or to another object within the virtual environment 30. In some implementations, the user input includes a gaze input that is directed away from the 3D virtual objects 140 (e.g., towards the window 34). In some implementations, when the user 12 is gazing away from the 3D virtual objects 140, the object presentation system 200 replaces the 3D virtual objects 140 with the 2D planes 40. In some implementations, the user input includes a gesture input that is directed away from the 3D virtual objects 140. For example, the gesture input may include a pinch-and-drag gesture directed at a window shade covering the window 34 (e.g., a request to open or close the window shade). In some implementations, when the user 12 gestures at another object, the object presentation system 200 replaces the 3D virtual objects 140 with the 2D planes 40. In some implementations, the user input includes a verbal command that is directed away from the 3D virtual objects 140 (e.g., towards another object in the virtual environment, for example, towards the window shade covering the window 34). For example, the user 12 may say “open” while gazing at the window shade covering the window 34. In some implementations, when the device 20 detects the verbal command directed away from the 3D virtual objects 140, the object presentation system 200 replaces the 3D virtual objects 140 with the 2D planes. Replacing the 3D virtual objects 140 with the 2D planes 40 in response to a lack of user interaction with the 3D virtual objects 40 for a threshold amount of time conserves graphics computing resources and reduces heat generation thereby enhancing a functionality of the device 20. In some implementations, the object presentation system 200 switches from displaying the 3D virtual objects 140 to displaying the 2D planes 40 based on a lack of user interaction with the 3D virtual objects 140 even when the user 12 is within the threshold distance 82 of the 3D virtual objects 140.

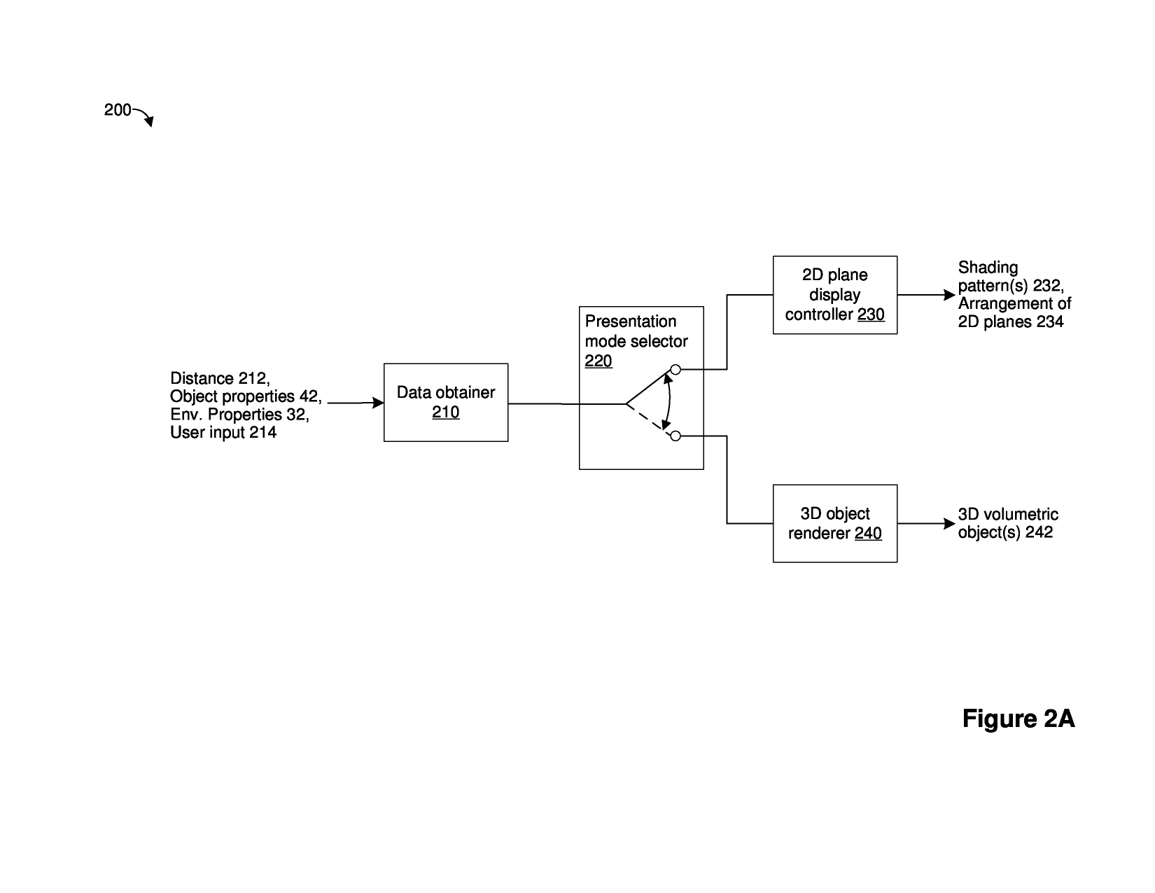

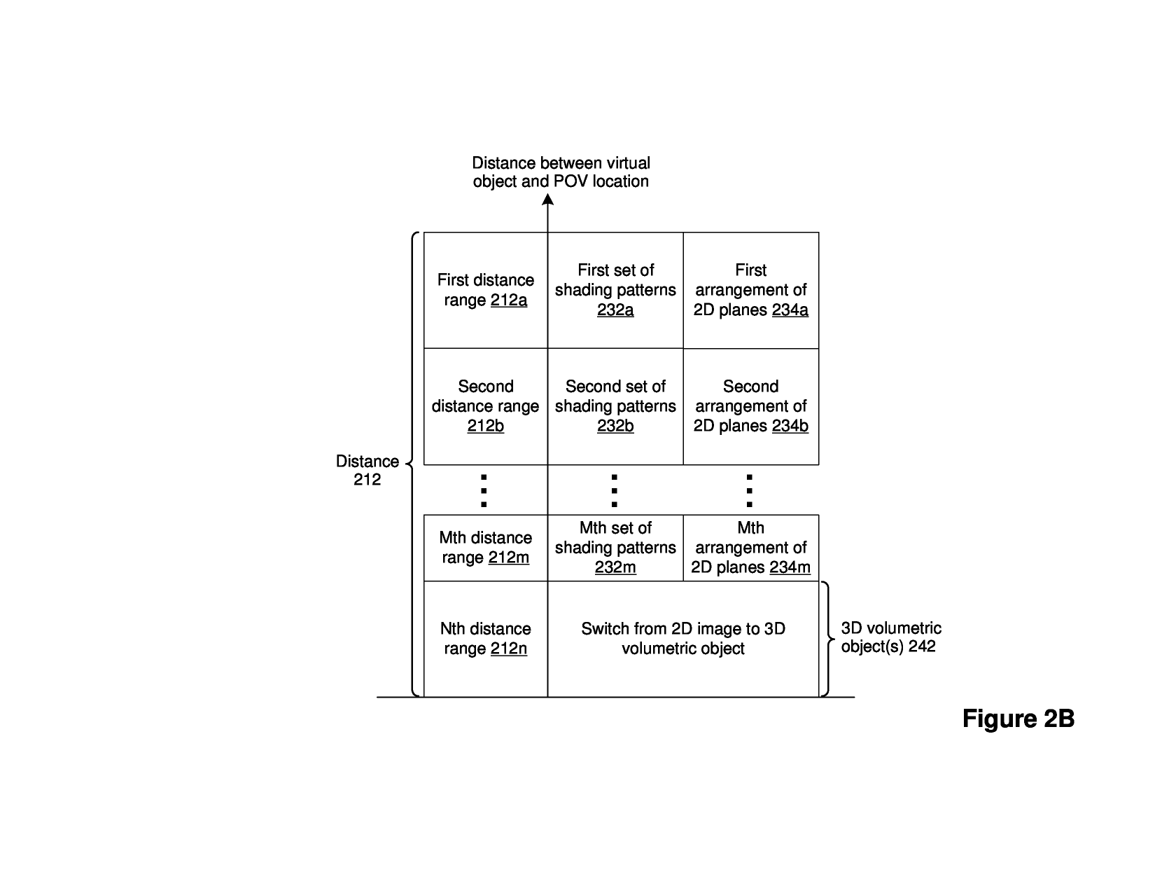

FIG. 2A is a block diagram of the object presentation system 200 in accordance with some implementations. In some implementations, the object presentation system 200 includes a data obtainer 210, a presentation mode selector 220, a 2D plane display controller 230 and a 3D object renderer 240.

In various implementations, the data obtainer 210 obtains a distance 212 between a POV location and a portion of a 3D virtual environment (e.g., a set of 3D virtual objects, for example, the first distance 80a shown in FIG. 1A, the second distance 80b shown in FIG. 1B, and the third distance 80c shown in FIG. 1D). The data obtainer 210 obtains the environment properties 32 and the object properties 42. The data obtainer 210 obtains a user input 214 (e.g., the gaze input 100, the gesture input 102 and the verbal command 104 shown in FIGS. 1E-1F).

In various implementations, the presentation mode selector 220 selects between a 2D presentation mode and a 3D presentation mode based on the data obtained by the data obtainer 210. As described in relation to FIGS. 1A-1D, the presentation mode selector 220 selects the 2D presentation mode when the distance 212 is greater than a threshold (e.g., the threshold distance 82 shown in FIGS. 1B-1D). The presentation mode selector 220 switches from the 2D presentation mode to the 3D presentation mode when the distance 212 decreases to a value that is below the threshold (e.g., as shown in FIG. 1D). As described in relation to FIGS. 1E-1F, in some implementations, the presentation mode selector 220 selects between the 2D presentation mode and the 3D presentation mode based on the user input 214. For example, as described in relation to FIGS. 1E-1F, the presentation mode selector 220 switches from the 2D presentation mode to the 3D presentation mode when the user input 214 is directed to the 2D planes 40. As another example, the presentation mode selector 220 switches from the 3D presentation mode to the 2D presentation mode when the user input 214 is directed away from the 3D virtual objects.

The 2D plane display controller 230 determines a set of shading patterns 232 to apply to 2D planes in the 2D presentation mode. For example, the 2D plane display controller 230 determines the first set of shading patterns 50 shown in FIG. 1A and the second set of shading patterns 52 shown in FIG. 1B. As described herein, the 2D plane display controller 230 utilizes a shading model to generate the shading pattern(s) 232. To that end, the 2D plane display controller 230 may utilize some of the data obtained by the data obtainer 210 to determine the shading pattern(s) 232. For example, in some implementations, the shading patterns 232 are a function of the environment properties 32 (e.g., lighting levels, illumination angle, light color, etc.) and/or the object properties 42 (e.g., object colors, reflectivity, materials, textures, etc.).

The 2D plane display controller 230 also determines an arrangement 234 of the 2D planes. For example, the 2D plane display controller 230 determines how to position the 2D planes in order to provide and/or maintain an appearance that the 2D planes collectively look like 3D virtual objects. In some implementations, determining the arrangement 234 of the 2D planes includes determining a number of 2D planes that are to be presented. The 2D plane display controller 230 can adjust a number of 2D planes that are displayed based on changes in POV. For example, as shown in FIG. 1C, the 2D plane display controller 230 can display additional 2D planes as the user gets closer to the 2D planes in order to maintain an appearance of 3D rendering.

The 3D object renderer 240 is invoked when the presentation mode selector 220 selects the 3D presentation mode. The 3D object renderer 240 generates a set of 3D volumetric objects 242 (e.g., the 3D virtual objects 140 shown in FIG. 1D). The 3D object renderer 240 tends to consume more graphics computing resources than the 2D plane display controller 230 and the 3D object renderer 240 tends to result in greater heat generation than the 2D plane display controller 230. Hence, the devices, methods and systems described herein reduce an amount of time that the 3D object renderer 240 is invoked and increase an amount of time that the 2D plane display controller 230 is invoked.

FIG. 2B illustrates selection of presentation modes and application of various shading patterns based on the distance 212. When the distance 212 is within a first distance range 212a, the presentation mode selector 220 selects the 2D presentation mode and the 2D plane display controller 230 determines a first arrangement 234a of 2D planes (e.g., a first number of 2D planes and/or a first set of positions for the 2D planes) and applies a first set of shading patterns 232a to the 2D planes. When the distance 212 is within a second distance range 212b that is smaller than the first distance range 212a, the presentation mode selector 220 maintains selection of the 2D presentation mode and the 2D plane display controller 230 switches from the first set of shading patterns 232a to a second set of shading patterns 232b in order to maintain the illusion of presenting the 3D virtual object(s). Additionally, the 2D plane display controller 230 may switch from the first arrangement 234a of the 2D planes to a second arrangement 234b of the 2D planes (e.g., a second number of 2D planes and/or a second set of positions for the 2D planes). When the distance 212 is within an mth distance range 212m that is smaller than the first distance range 212a, the second distance range 212b and other preceding distance ranges, the presentation mode selector 220 maintains selection of the 2D presentation mode and the 2D plane display controller 230 switches to an mth set of shading patterns 232m in order to maintain the illusion of presenting the 3D virtual object(s). Additionally, the 2D plane display controller 230 may switch to an mth arrangement 234m of the 2D planes (e.g., an mth number of 2D planes and/or an mth set of positions for the 2D planes). When the distance 212 is within an nth distance range 212n that is smaller than the first distance range 212a, the second distance range 212b, …, and the mth distance range 212m, the presentation mode selector 220 switches from the 2D presentation mode to the 3D presentation mode and the 3D object renderer 240 displays the 3D volumetric object(s) 242.

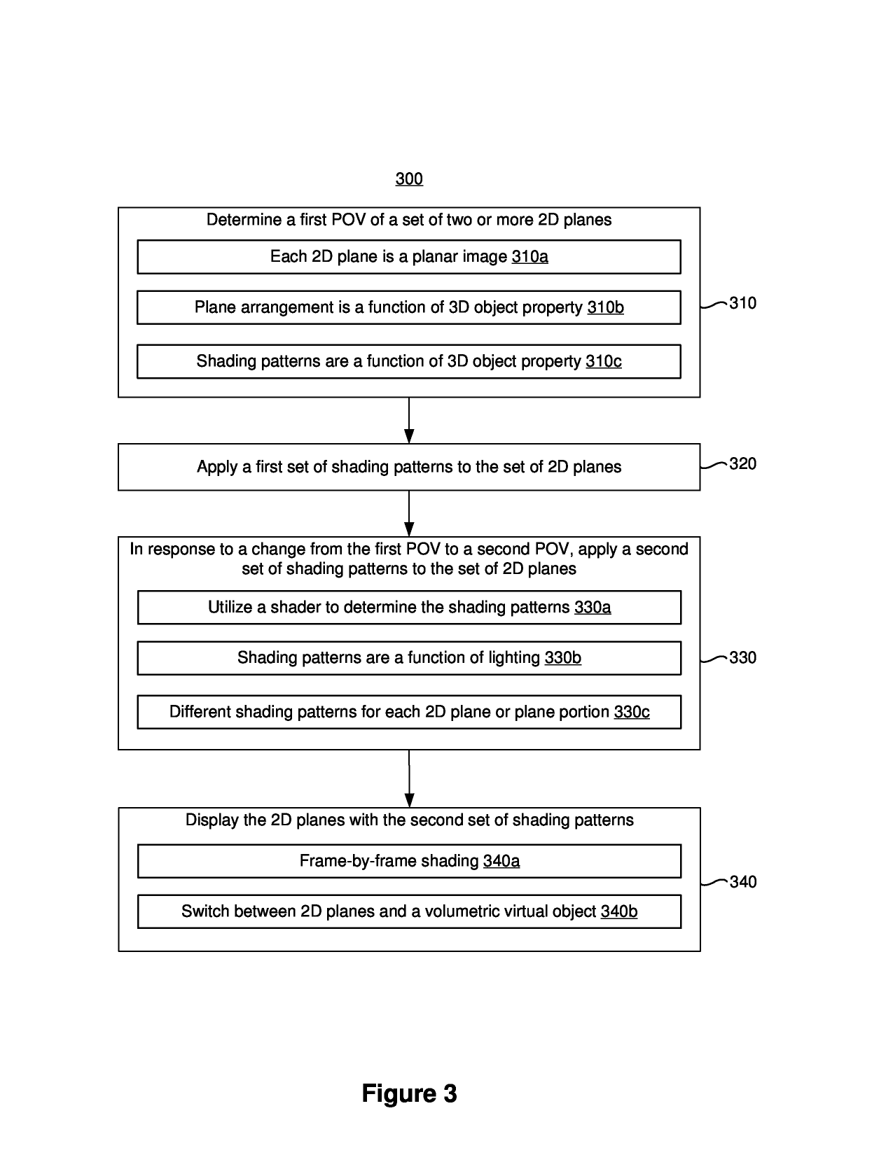

FIG. 3 is a flowchart representation of a method 300 for presenting a portion of a 3D virtual environment using dynamically-shaded 2D planes. In various implementations, the method 300 is performed by a device including a display, a non-transitory memory and one or more processors coupled with the display and the non-transitory memory (e.g., the device 20 shown in FIGS. 1A-1F and/or the object presentation system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes determining a first point-of-view (POV) of a set of two or more two-dimensional (2D) planes in a virtual environment from a user location characterized by a set of coordinates in the virtual environment and a distance between the set of two or more 2D planes and the user location. For example, as shown in FIG. 1A, the device 20 displays the virtual environment 30 from the first POV 70a.

As represented by block 310a, in some implementations, each 2D plane in the set of two or more 2D planes is a planar image. For example, referring to FIG. 1A, in some implementations, the first 2D plane 40a is a first image and the second 2D plane 40b is a second image.

As represented by block 310b, in some implementations, an arrangement of the two or more 2D planes is a function of a visual property of the 3D virtual object. In some implementations, a distance between the 2D planes is a function of a dimension of the 3D virtual object. In some implementations, an orientation of the 2D planes with respect to each other is a function of a geometry of the 3D virtual object that the 2D planes represent. For example, if the 2D planes represent intersecting 3D virtual walls, then the 2D planes intersect. As another example, if the 2D planes represent opposing 3D virtual walls, then the 2D planes are displayed in parallel.

In some implementations, the set of two or more 2D planes includes a first 2D image and a second 2D image, and the first 2D image and the second 2D image intersect to form an edge of the 3D virtual object that the set of two or more 2D planes represent. For example, as shown in FIGS. 1A and 1B, the first 2D plane 40a and the second 2D plane 40b intersect to form an edge.

In some implementations, the set of two or more 2D planes includes a first 2D image, a second 2D image and a third 2D image, and the first 2D image, the second 2D image and the third 2D image intersect to form a corner of the 3D virtual object that the set of two or more 2D planes represent. For example, as shown in FIG. 1C, the first 2D plane 40a, the second 2D plane 40b and the third 2D plane 40c intersect to form a corner. In some implementations, the device performs a blending operation on respective portions of the 2D images that are adjacent to the intersection of the 2D images in order to make the intersection look like a 3D edge or a 3D corner.

In some implementations, the set of two or more 2D planes includes a first 2D image and a second 2D image that is displayed in parallel to the first 2D image. For example, when the 2D planes represent 3D virtual objects that are positioned parallel to each other in the 3D virtual environment, for example, when the 2D planes represent opposing 3D virtual walls.

As represented by block 310c, in some implementations, the first set of one or more shading patterns is a function of a property of the 3D virtual object. For example, as discussed in relation to FIG. 1A, the first set of shading patterns 50 is a function of the object properties 42 and/or the environment properties 32. As an example, the first set of one or more shading patterns indicate reflective surfaces when the 3D virtual object has a reflectivity that is greater than a threshold.

As represented by block 320, in various implementations, the method 300 includes applying a first set of one or more shading patterns to the set of two or more 2D planes based on the first POV in order to make the set of two or more 2D planes appear as a three-dimensional (3D) virtual object from the first POV. For example, as shown in FIG. 1A, the object presentation system 200 applies the first set of shading patterns 50 to the 2D planes 40 based on the first distance 80a.

As represented by block 330, in some implementations, the method 300 includes, in response to a change from the first POV to a second POV, determining a second set of one or more shading patterns based on the second POV in order to make the set of two or more 2D planes appear as the 3D virtual object from the second POV. For example, as shown in FIG. 1B, the object presentation system 200 determines the second set of shading patterns 52 for the 2D planes 40 based on the second distance 80b.

As represented by block 330a, in some implementations, the method 300 includes utilizing a shader to determine the first set of one or more shading patterns and the second set of one or more shading patterns. For example, referring to FIG. 2A, the 2D plane display controller 230 includes a shader that determines the shading pattern(s) 232.

As represented by block 330b, in some implementations, the first set of one or more shading patterns and the second set of one or more shading patterns are a function of a lighting condition of the virtual environment. For example, as described in relation to FIG. 2A, the shading pattern(s) 232 is(are) a function of the environment properties 32.

As represented by block 330c, in some implementations, the set of two of more 2D planes includes a first 2D image and a second 2D image. The first set of one or more shading patterns includes a first shading pattern for the first 2D image and a second shading pattern for the second 2D image. The second set of one or more shading patterns includes a third shading pattern for the first 2D image and a fourth shading pattern for the second 2D image. In some implementations, the device captures images of a 3D virtual object from different perspectives and uses the captured images as the first 2D image and the second 2D image.

As represented by block 340, in some implementations, the method 300 includes displaying, on the display, the set of two or more 2D planes with the second set of one or more shading patterns. For example, as shown in FIG. 1B, the device 20 displays the 2D planes 40 with the second set of shading patterns 52. As described herein, applying the second set of shading patterns is computationally cheaper than rendering a 3D virtual object while maintaining the illusion of displaying the 3D virtual object thereby providing a satisfactory user experience without having to utilize excess computational resources.

As represented by block 340a, in some implementations, the method 300 includes applying new shading patterns to the set of two or more 2D planes on a frame-by-frame basis. For example, as the POV changes or environment conditions change across a sequence of frames, the device determines and applies other sets of shading patterns to the 2D planes that are more suitable for the changing POV and environment conditions.

As represented by block 340b, in some implementations, the method 300 includes replacing the set of two or more 2D planes with a volumetric virtual object when the distance between the user location and the set of two or more 2D planes breaches a threshold. For example, as shown in FIG. 1D, the object presentation system 200 switches from displaying the 2D planes 40 to displaying the 3D virtual objects 140 when the third distance 80c is less than the threshold distance 82.

In some implementations, the method 300 includes replacing a volumetric virtual object with the set of two or more 2D planes when the distance between the user location and the volumetric virtual object breaches a threshold (e.g., when the distance becomes greater than the threshold). For example, the device switches from displaying the volumetric virtual object(s) to displaying the 2D planes when the distance between the volumetric virtual object(s) and the user location increases beyond the threshold distance 82 shown in FIGS. 1B and 1C.

In some implementations, the method 300 includes replacing the set of two or more 2D planes with a volumetric virtual object in response to interactions with a portion of the set of two or more 2D planes. For example, as shown in FIGS. 1E-1F, the device 20 switches from displaying the 2D planes 40 to displaying the 3D virtual objects 140 based on a combination of the inputs 100, 102 and 104. In some implementations, the method 300 includes replacing the set of two or more 2D planes with a volumetric virtual object in response to a gaze input.

In some implementations, the method 300 includes converting a volumetric virtual object to the set of two or more 2D planes in response to a lack of interactions for a threshold amount of time. For example, referring to FIG. 1D, the device 20 switches from displaying the 3D virtual objects 140 to displaying the 2D planes 40 based on a user input that is directed away from the 3D virtual objects 140 (e.g., when the user 12 is gazing at the window 34).

In some implementations, the method 300 includes replacing a volumetric virtual object with the set of two or more 2D images when the volumetric virtual object is in a periphery of a user of the device. For example, referring to FIG. 1D, if the user 12 rotates his/her head away from the 3D virtual objects 140 so that the 3D virtual objects 140 are in a periphery of the user 12, the device 20 can replace the 3D virtual objects 140 with the 2D planes 40.

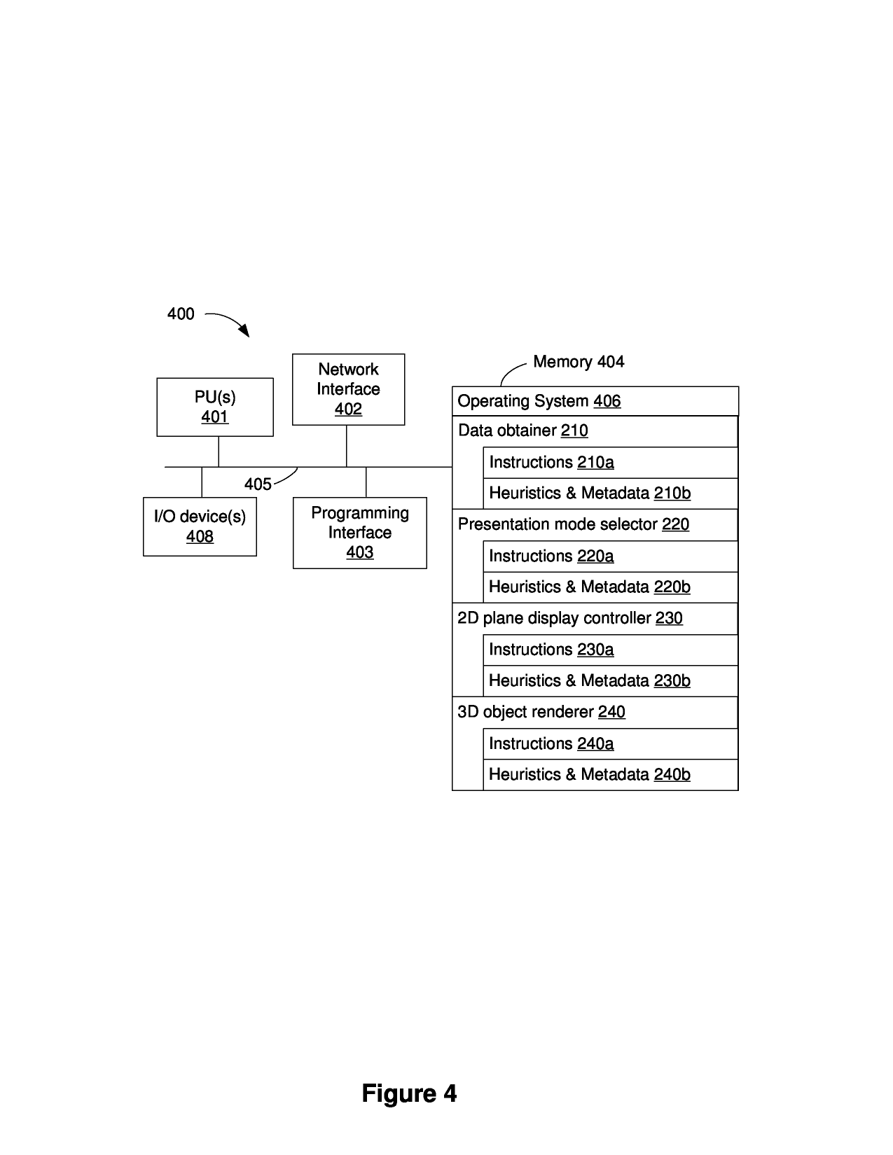

FIG. 4 is a block diagram of a device 400 in accordance with some implementations. In some implementations, the device 400 implements the device 20 shown in FIGS. 1A-1F and/or the object presentation system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the presentation mode selector 220, the 2D plane display controller 230 and the 3D object renderer 240. In various implementations, the device 400 performs the method 300 shown in FIG. 3.

In some implementations, the data obtainer 210 includes instructions 210a, and heuristics and metadata 210b for obtaining data (e.g., the distance 212, the object properties 42, the environment properties 32 and the user input 214 shown in FIG. 2A). In some implementations, the data obtainer 210 performs at least some of the operation(s) represented by block 310 in FIG. 3.

In some implementations, the presentation mode selector 220 includes instructions 220a, and heuristics and metadata 220b for selecting between a 2D presentation mode and a 3D presentation mode.

In some implementations, the 2D plane display controller 230 includes instructions 230a, and heuristics and metadata 230b for determining and applying shading patterns (e.g., the shading patterns 50 and 52 shown in FIGS. 1A and 1B, respectively) to 2D planes in order to make the 2D planes appear as a set of 3D virtual objects. In some implementations, the 2D plane display controller 230 performs at least some of the operation(s) represented by blocks 320, 330 and 340 in FIG. 3.

In some implementations, the 3D object renderer 240 includes instructions 240a, and heuristics and metadata 240b for displaying a 3D virtual object (e.g., the 3D virtual objects 140 shown in FIG. 1D).

In some implementations, the one or more I/O devices 408 include a set of one or more sensors for detecting user inputs. For example, the one or more I/O devices 408 include an eye tracker for detecting gaze inputs, a gesture tracker for detecting gestures and a microphone for detecting verbal commands.

In various implementations, the one or more I/O devices 408 include a video pass-through display which displays at least a portion of a physical environment surrounding the device 400 as an image captured by the camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a non-transitory memory, an input device, a display and one or more processors:
determining a first point-of-view (POV) of a set of two or more two-dimensional (2D) planes in a virtual environment from a user location characterized by a set of coordinates in the virtual environment and a distance between the set of two or more 2D planes and the user location;
applying a first set of one or more shading patterns to the set of two or more 2D planes based on the first POV in order to make the set of two or more 2D planes appear as a three-dimensional (3D) virtual object from the first POV;
in response to a change from the first POV to a second POV, determining a second set of one or more shading patterns based on the second POV in order to make the set of two or more 2D planes appear as the 3D virtual object from the second POV; and
displaying, on the display, the set of two or more 2D planes with the second set of one or more shading patterns.

2. The method of claim 1, wherein each 2D plane in the set of two or more 2D planes is a planar image.

3. The method of claim 1, wherein an arrangement of the two or more 2D planes is a function of a visual property of the 3D virtual object.

4. The method of claim 1, wherein the set of two or more 2D planes includes a first 2D image and a second 2D image, and the first 2D image and the second 2D image intersect to form an edge of the 3D virtual object that the set of two or more 2D planes represents.

5. The method of claim 1, wherein the set of two or more 2D planes includes a first 2D image, a second 2D image and a third 2D image, and the first 2D image, the second 2D image and the third 2D image intersect to form a corner of the 3D virtual object that the set of two or more 2D planes represent.

6. The method of claim 1, wherein the set of two or more 2D planes includes a first 2D image and a second 2D image that is displayed in parallel to the first 2D image.

7. The method of claim 1, wherein the first set of one or more shading patterns is a function of a property of the 3D virtual object.

8. The method of claim 1, further comprising applying new shading patterns to the set of two or more 2D planes on a frame-by-frame basis.

9. The method of claim 1, further comprising replacing the set of two or more 2D planes with a volumetric virtual object when the distance between the user location and the set of two or more 2D planes breaches a threshold.

10. The method of claim 1, further comprising replacing a volumetric virtual object with the set of two or more 2D planes when the distance between the user location and the volumetric virtual object breaches a threshold.

11. The method of claim 1, further comprising replacing the set of two or more 2D planes with a volumetric virtual object in response to interactions with a portion of the set of two or more 2D planes.

12. The method of claim 1, further comprising converting a volumetric virtual object to the set of two or more 2D planes in response to a lack of interactions for a threshold amount of time.

13. The method of claim 1, further comprising replacing the set of two or more 2D planes with a volumetric virtual object in response to a gaze input.

14. The method of claim 1, further comprising replacing a volumetric virtual object with the set of two or more 2D planes when the volumetric virtual object is in a periphery of a user of the device.

15. The method of claim 1, further comprising utilizing a shader to determine the first set of one or more shading patterns and the second set of one or more shading patterns.

16. The method of claim 1, wherein the first set of one or more shading patterns and the second set of one or more shading patterns are a function of a lighting condition of the virtual environment.

17. The method of claim 1, wherein the set of two of more 2D planes includes a first 2D image and a second 2D image;
wherein the first set of one or more shading patterns includes a first shading pattern for the first 2D image and a second shading pattern for the second 2D image; and
wherein the second set of one or more shading patterns includes a third shading pattern for the first 2D image and a fourth shading pattern for the second 2D image.

18. A device comprising:
a non-transitory memory;
an input device;
a display; and
one or more processors to:
determine a first point-of-view (POV) of a set of two or more two-dimensional (2D) planes in a virtual environment from a user location characterized by a set of coordinates in the virtual environment and a distance between the set of two or more 2D planes and the user location;
apply a first shading pattern to the set of two or more 2D planes based on the first POV in order to make the set of two or more 2D planes appear as a three-dimensional (3D) virtual object from the first POV;
in response to a change from the first POV to a second POV, determine a second shading pattern based on the second POV in order to make the set of two or more 2D planes appear as the 3D virtual object from the second POV; and
display, on the display, the set of two or more 2D planes with the second shading pattern.

19. The device of claim 18, wherein an arrangement of the two or more 2D planes is a function of a visual property of the 3D virtual object.

20. A non-transitory memory storing one or more programs, which, when executed by one or more processors of a device including an input device and a display, cause the device to:
determine a first point-of-view (POV) of a set of two or more two-dimensional (2D) planes in a virtual environment from a user location characterized by a set of coordinates in the virtual environment and a distance between the set of two or more 2D planes and the user location;
apply a first shading pattern to the set of two or more 2D planes based on the first POV in order to make the set of two or more 2D planes appear as a three-dimensional (3D) virtual object from the first POV;
in response to a change from the first POV to a second POV, determine a second shading pattern based on the second POV in order to make the set of two or more 2D planes appear as the 3D virtual object from the second POV; and
display, on the display, the set of two or more 2D planes with the second shading pattern.
